(19) United States
(12) Patent Application Publication
(10) Pub. No.: US 2026/0095435 A1
(43) Pub. Date: Apr. 2, 2026

(54) SYSTEMS AND METHODS FOR MONITORING A COMMUNICATION NETWORK

(71) Applicant: Apple Inc., Cupertino, CA (US)

(72) Inventors: Obaid Mirza, Union City, CA (US); Satinder Singh Randhawa, San Jose, CA (US); Sarvesh Kumar Varatharajan, Milpitas, CA (US); Venkateswara Rao Manepalli, San Jose, CA (US); Thanigaivelu Elangovan, Cupertino, CA (US); Someet K. Lal, Fremont, CA (US)

(21) Appl. No.: 19/278,246

(22) Filed: Jul. 23, 2025

Related U.S. Application Data
(60) Provisional application No. 63/699,963, filed on Sep. 27, 2024.

(51) Int. Cl. H04L 61/58; H04W 60/00

(52) U.S. Cl. CPC H04L 61/58; H04W 60/00

(57) ABSTRACT

Embodiments described herein relate to techniques for monitoring accessory devices on a wireless mesh network, such as a Thread network. An electronic device may employ a network module, an application module, and a service registration module to communicate with the accessory devices in an environment. The network module may include a network reachability monitor that scans for the accessory devices periodically and receives accessory device data associated with each of the accessory devices that are reachable or responsive and store the accessory device data in a list. The network reachability monitor stores the list in an address cache. Further, the network reachability monitor receives a request for an Internet Protocol (IP) address of an accessory device, retrieves the IP address from the list, and transmits the IP address to the application module or the service registration module to enable communication with the accessory device.

### CROSS-REFERENCE TO RELATED APPLICATIONS

This application claims priority to U.S. Provisional Application No. 63/699,963, filed Sep. 27, 2024, which is incorporated by reference herein in its entirety.

### BACKGROUND

The present disclosure relates generally to wireless communication, and more specifically to accessing and/or monitoring accessory devices on a wireless mesh network.

An electronic device may communicate with accessory devices on a wireless mesh network (e.g., Thread network) by employing an application (e.g., Thread) module, a network protocol (e.g., Matter) module), and/or a service registration module, each of which may operate on its own independent domain. The application module may request an Internet Protocol (IP) address of an accessory device from the service registration module to communicate with the accessory device. However, the service registration module may return a stale IP address due to unreachability (e.g., unresponsiveness) of the accessory device, preventing the application module from communicating with the accessory device. As a result, the application module and the network module may each enter respective (e.g., independent) back off modes at separate times. Desynchronization between the back off modes of the network module and the application module may extend a duration of an outage and/or a duration of connectivity issues between the electronic device and the accessory device.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. This disclosure may encompass a variety of aspects that may not be set forth below.

In one embodiment, one or more tangible, non-transitory computer-readable media storing instructions that, when executed by processing circuitry, are configured to cause the processing circuitry to scan for one or more accessory devices, receive one or more addresses associated with the one or more accessory devices, and generate a list based on the one or more addresses. The instructions, when executed by the processing circuitry, also cause the processing circuitry to receive a request to communicate with an accessory device of the one or more accessory devices, and transmit an address of the one or more addresses associated with the accessory device based on the list.

In another embodiment, an electronic device includes a transmitter, a receiver, and processing circuitry coupled to the transmitter and the receiver, the processing circuitry configured to cause the receiver to scan for one or more accessory devices at a first time, cause the receiver to receive one or more addresses associated with the one or more accessory devices, and generate a list based on the one or more addresses. The processor also configured to cause the receiver to receive a request to communicate with an accessory device of the one or more accessory devices, and cause the transmitter to transmit an address of the one or more addresses associated with the accessory device based on the list.

In yet another embodiment, a method to be performed by processing circuitry includes scanning for one or more accessory devices, receiving one or more addresses associated with the one or more accessory devices, and generating a list based on the one or more addresses. The method also includes receiving, via the processing circuitry, a request to communicate with an accessory device of the one or more accessory devices, and preparing for transmission, an address of the one or more addresses associated with the accessory device based on the list.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a wireless mesh network that may include the electronic device of FIG. 1, according to embodiments of the present disclosure;

FIG. 4 is a block diagram the electronic device of FIG. 1 having a network reachability monitor to facilitate communication with accessory devices via the wireless mesh network of FIG. 3, according to embodiments of the present disclosure;

FIG. 5 is a block diagram of a flow of data within the electronic device of FIG. 1 including the network reachability monitor to communicate with the accessory devices of FIG. 4, according to embodiments of the present disclosure;

FIG. 6 is a flow diagram of a process for the network reachability monitor of FIG. 5 to transmit an IP address of an accessory device, according to embodiments of the present disclosure;

FIG. 7 is a flow diagram of a process for the electronic device of FIG. 1 to generate a list including accessory device data, according to embodiments of the present disclosure;

FIG. 8 is a flow diagram of a process for the electronic device of FIG. 1 to perform an active scan, according to embodiments of the present disclosure;

FIG. 9 is a flow diagram of a process for the electronic device of FIG. 1 to perform an active scan, according to embodiments of the present disclosure; and

FIG. 10 is a block diagram of a network module of the electronic device of FIG. 1, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 % of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to techniques for monitoring one or more accessory devices on a wireless mesh network, such as a Thread network. For example, an electronic device may employ a network (e.g., Thread) module, an application (e.g., Matter) module, and/or a service registration (e.g., a Service Registration Protocol (SRP)/Multicast Domain Name System (mDNS)) module to communicate with the one or more accessory devices in an environment. The network module may include a network reachability monitor (e.g., Thread reachability monitor) that may scan (e.g., broadcast a discovery request) for one or more accessory devices periodically (e.g., one or more intervals). That is, the network reachability monitor may perform a proactive or passive scan of the one or more accessory devices. The network reachability monitor may then receive accessory device data associated with each of the one or more accessory devices that are reachable or responsive and store the accessory device data in a list. The accessory device data may include a state (e.g., reachable, responsive) of the accessory device, an IP address of the accessory device, a received signal strength indicator (RSSI) of the accessory device, a type of the accessory device, a time of a last resolved IP address of the accessory device, and any other suitable accessory device data. In an embodiment, the network reachability monitor may also determine and maintain a score of highest (e.g., best) performing accessory devices and lowest (e.g., worst) performing accessory devices in the list based on the accessory device data.

Additionally, the network reachability monitor may store the list in a database, such as an address cache, of the network module. The network reachability monitor may receive a request for an IP address of an accessory device of the one or more accessory devices, retrieve the IP address from the list, and transmit the IP address to the application module or the service registration module. In this manner, the network module may employ the network reachability monitor to efficiently provide the accessory device data of the one or more accessory devices to the application module and/or the service registration module and enable communication with the accessory device.

In an embodiment, the network reachability monitor may perform the scan based on receiving an indication of a status change of a network or an accessory device. That is, the network reachability monitor may perform an active scan in response to the status change of the network or the accessory device. For example, the status change of the network may include a network topology change, a partition change, a reachability trigger, or any other suitable status change. As another example, the status change of the accessory device may include the accessory device becoming unreachable. Thus, the network reachability monitor may perform a scan for the one or more accessory devices stored in the address cache and determine the accessory device of the one or more accessory devices is unreachable. The network reachability monitor may move (e.g., transfer) an IP address of the unreachable accessory device from the address cache to a failed address cache. Further, the network reachability monitor may transmit a notification to the application module and/or the service registration module that the accessory device is unreachable.

In an embodiment, the network reachability monitor may transmit an additional notification to the application module and/or the service registration module to stop reaching the unreachable accessory device. In this manner, the additional notification may prevent the application module and/or the service registration module from each triggering a back off mode thus reducing or minimizing a duration of an outage and/or a duration of connectivity issues. Additionally, the network reachability monitor may employ a background monitor to re-scan for the unreachable accessory device at pre-determined (e.g., specified) times and determine the unreachable accessory device is reachable. By scanning for the unreachable accessory device at pre-determined times, the network reachability monitor may reduce or minimize an amount of network traffic (e.g., network congestion) on the communication network.

The network reachability monitor may then move the IP address of the reachable accessory from the failed address cache to the address cache. The network reachability monitor may then transmit a notification to the application module and/or the service registration module to initiate reconnection with the accessory device. Accordingly, embodiments described herein may enable the application module and/or the service registration module to efficiently communicate with the one or more accessory devices. Additionally, embodiments described herein may reduce or minimize desynchronization between the back off modes of the network module and the application module, reducing the duration of the outage and/or the duration of the connectivity issues.

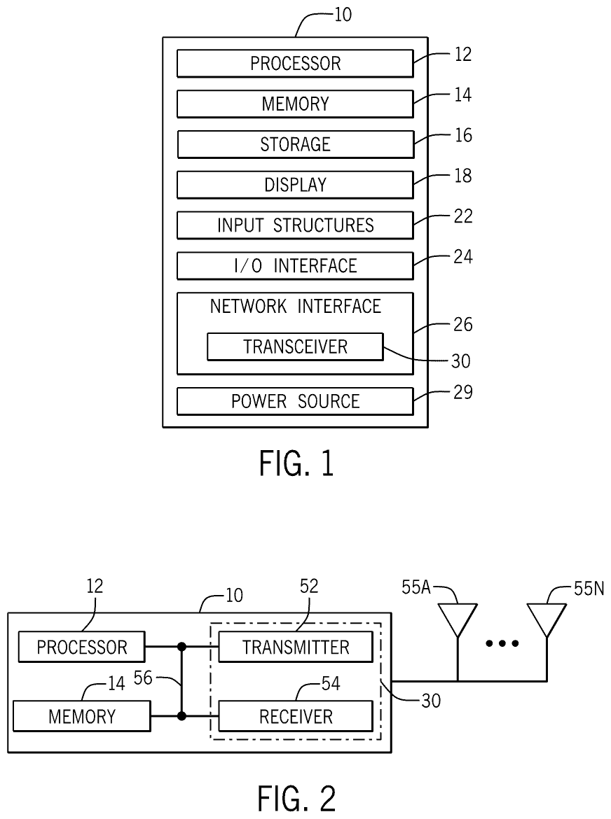

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH network, a local area network (LAN) or wireless local area network (WLAN), such as a network employing one of the IEEE 802.11x family of protocols (e.g., WI-FI), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, Long Term Evolution (LTE) cellular network, Long Term Evolution License Assisted Access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX), mobile broadband Wireless networks (mobile WIMAX), asynchronous digital subscriber lines (e.g., ADSL, VDSL), digital video broadcasting-terrestrial (DVB-T) network and its extension DVB Handheld (DVB-H) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. As an example, the transceiver 30 may support transmission and/or reception of wireless mesh network signals, including Thread signals, to enable communication with a wireless mesh network, including a Thread network. The power source 29 of the electronic device 10 may include any suitable source of power, such as a rechargeable lithium polymer (Li-poly) battery and/or an alternating current (AC) power converter.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The electronic device 10 may include the transmitter 52 and/or the receiver 54 that respectively enable transmission and reception of signals between the electronic device 10 and an external device via, for example, a network (e.g., including base stations or access points) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

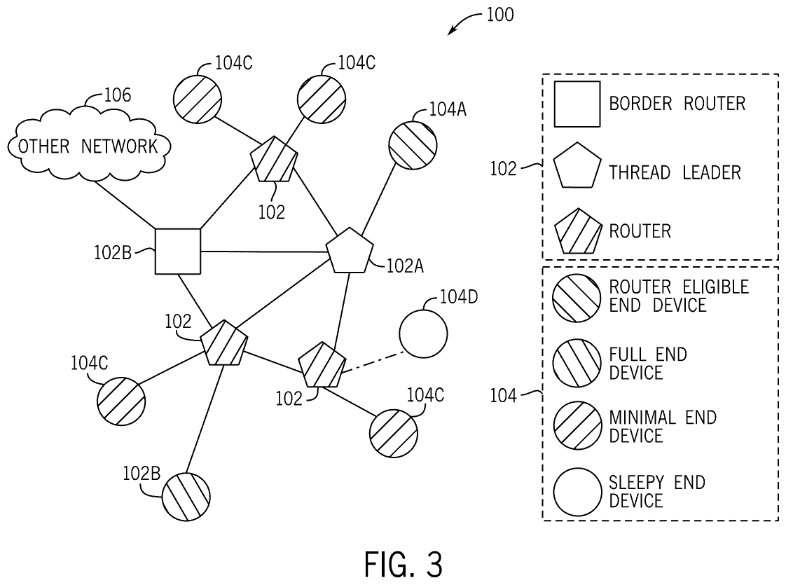

FIG. 3 is a schematic diagram of a wireless network 100 to which the electronic device 10 may be coupled. In particular, the wireless network 100 may include a wireless mesh network or a Low-Rate Wireless Personal Area Network (LR-WPAN), and, even more particularly, a Thread network. While the techniques described herein may be described with respect to the Thread network, it should be noted that the techniques may be utilized with other types of wireless networks, including, but not necessarily limited to, any IEEE Standard 802.15.4 network, such as a ZigBee network. For example, the techniques of the present disclosure may be utilized in a wireless mesh network, which generally refers to a wireless network that utilizes a mesh topology. For instance, a wireless mesh network may follow a WLAN topology in which the nodes (e.g., devices coupled to the mesh network) couple directly, dynamically, and/or non-hierarchically to other nodes (e.g., as many nodes as possible) and cooperate with one another to route data to and from devices. Wireless mesh networks include, but are not limited to, IEEE Standard 802.15.4 networks.

The wireless network 100 includes several nodes (e.g., routers 102 and accessory devices 104) that are coupled to one another as illustrated in FIG. 3. Each of the nodes may include an electronic device that is part of the wireless network 100. As illustrated, there are several types of nodes in the wireless network 100. Depending on the capabilities of the electronic device 10, the electronic device 10 may be one or more of any of the types of nodes. The particular types of nodes included in the wireless network 100 include routers 102 (collectively referring to routers 102 (e.g., routers that are not further classified as discussed below), thread leader 102A, and border router 102B) and the accessory devices 104 (collectively referring to accessory devices 104A, 104B, 104C, 104D). The routers 102 include nodes that forward packets for network devices, provide secure commissioning services for devices attempting to join the wireless network 100, and keep their transceiver(s) enabled at all times. The accessory devices 104 (e.g., end devices) include nodes that do not forward packets for other network devices, communicate (primarily) with a single router 102, and may disable their transceiver(s) to reduce power. As discussed below, the routers 102 and some accessory devices 104 may also be classified as full Thread devices, while other accessory devices 104 may be classified as minimal Thread devices. A full Thread device may always have its radio on, maintain IPv6 address mappings, and subscribe to an all-routers multicast address. Minimal Thread devices may not subscribe to the all-routers multicast address and forward their messages to a router 102 (or an accessory device 104 that is functioning as a router 102).

Within the classification of the routers 102, there may be several types of routers 102. For example, a router 102 may include a thread leader 102A, which manages the other routers in the wireless network 100. A router 102 may also include a border router 102B, which is a device that can forward data to another network 106, such as a network other than a Thread network (e.g., a Wi-Fi® network). The routers 102 may include full Thread devices.

Within the classification of the accessory devices 104, there are router eligible end devices 104A, full end devices 104B, minimal end devices 104C, and sleepy end devices 104D. Router eligible end devices 104A and full end devices 104B may include full Thread devices. More specifically, router eligible end devices 104A may include end devices 104 that can be promoted to function as a router 102, while full end devices 104B may include end devices 104 that are full Thread devices but cannot be promoted to be a router 102. Minimal end devices 104C and sleepy end devices 104D may include minimal Thread devices. In particular, a minimal end device 104C does not need to poll for messages sent from the router 102 to which the minimal end device 104C is coupled, and the minimal end device's 104C transceiver may always be on. A sleepy end device 104D may include an end device 104 that is typically in sleep and wakes up occasionally to poll for messages from the router 102 to which it is coupled. In an embodiment, the electronic device 10 may be a device capable of routing (e.g., a router 102, a router eligible end device 104A, a full end device 104B, and so on).

The wireless network 100 may be implemented indoors (e.g., within a dwelling or office space), outdoors, or both. The nodes may include electrical devices including, but not limited to, the electronic devices listed above that the electronic device 10 may be. For instance, the nodes (which include the electronic device 10) may be a phone, tablet, computer, a portable electronic or handheld electronic, a wearable electronic device, a smart speaker, home automation equipment (including, but not limited to switches, outlets, controllers, irrigation or sprinkler system equipment, sensors, lights, thermostats), a smart appliance, a smart door lock, wireless routers, network extenders, or power equipment), or any combination thereof.

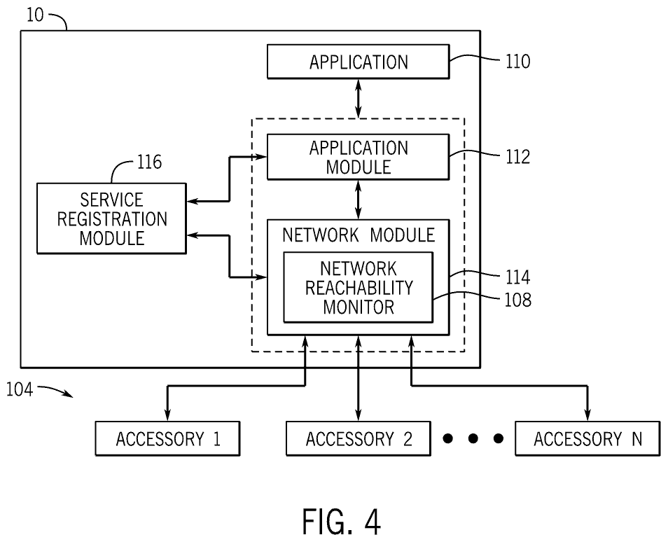

FIG. 4 is a block diagram of the electronic device 10 of FIG. 1 having a network reachability monitor 108 to facilitate communication with the accessory devices 104 via the network 100 (e.g., the wireless mesh network). It should be noted that the electronic device 10 may be in communication with a single accessory device 104 or multiple accessory devices 104. The electronic device 10 may execute (e.g., run, launch) an application 110 that may connect to and/or interact with the accessory devices 104 (e.g., via a graphical user interface). The electronic device 10 may store the application 110 in the memory 14 of the electronic device 10 and execute the application 110 using the processor 12 of the electronic device 10. In some embodiments, the application 110 may include a smart home application, a smart appliance application, a home network application, and so on.

The electronic device 10 may also employ an application (e.g., Matter) module 112, a network (e.g., Thread) module 114, and/or a service registration (e.g., Service Registration Protocol (SRP)/Multicast Domain Name System (mDNS)) module 116 to communicate with the accessory devices 104 on the network 100. The application module 112 may define an application layer of an Open Systems Interconnection (OSI) model. That is, the application module 112 may define one or more protocols and one or more rules that enable devices (e.g., the electronic device 10, the routers 102, the accessory devices 104) to communicate with one another. The application module 112 may provide a framework for device discovery, control, and/or communication to enable seamless interaction between the devices (e.g., irrespective of underlying network technology, such as Ethernet, Wi-Fi, and Thread). For example, the application module 112 may provide a standard application programming interface (API) for device communication and control.

The network module 114 may operate at a network layer (e.g., over Internet Protocol version 6 (IPv6) of the OSI model and enable creation (e.g., formation) of the network 100 and/or management, such as routing, on the network 100 between the electronic device 10, the routers 102, and/or the accessory devices 104. The network module 114 may enable the electronic device 10, the routers 102, and/or the accessory devices 104 to exchange data across the network 100. Further, the service registration module 116 may facilitate discovery and/or registration of services corresponding to devices on the network 100. Additionally, the service registration module 116 may employ mDNS to enable other devices on the network 100 to query for available services. For example, mDNS may include a cache that stores accessory details, such as IP addresses associated with the accessory devices 104. Therefore, the service registration module 116 may employ mDNS for device name resolution and multicast queries.

As an example, the electronic device 10 may execute the application 110 to communicate with an accessory device 104 of the accessory devices 104 on the network 100 (e.g., Thread network set up by the network module 114). The application 110 may employ the application module 112 to discover and interact with the accessory device 104, such as by sending a discovery request or an initiation command. The application module 112 may then request an Internet Protocol (IP) address of the accessory device 104 from the service registration module 116. The service registration module 116 may provide (e.g., return) the IP address of the accessory device 104 to the application module 112 to enable the application module 112 to communicate with the accessory device 104 using the network module 114. However, if the accessory device 104 becomes unreachable, the service registration module 116 may provide a stale IP address, preventing the application module 112 from communicating with the accessory device 104.

Therefore, the network module 114 may include a network reachability monitor 108 (e.g., Thread reachability monitor) to scan for the accessory devices 104 periodically (e.g., at one or more configurable intervals) and maintain a list (e.g., routing table) in a database, such as an address cache, that includes accessory device data associated with each of the accessory devices 104. For example, the accessory device data may include a state (e.g., reachable, responsive) of the accessory device 104, an IP address of the accessory device 104, a received signal strength indicator (RSSI) of the accessory device 104, a type of the accessory device 104, a time of a last resolved IP address of the accessory device 104, and/or any other suitable accessory device information. In an embodiment, the network reachability monitor 108 may also determine a score of highest (e.g., best) performing accessory devices 104 and lowest (e.g., worst) performing accessory devices 104. Thus, the network reachability monitor 108 may store a list including the accessory device data and/or the score of the highest performing accessory devices 104 and the lowest performing accessory devices 104 in a database, such as an address cache.

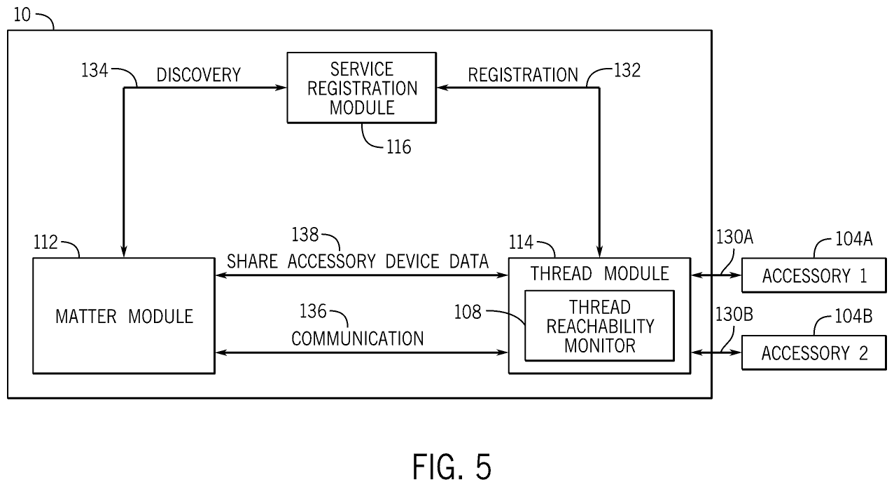

In this manner, the network reachability monitor 108 may efficiently provide the accessory device data of the accessory devices 104 to the application module 112 and/or the service registration module 116. Moreover, if the accessory device 104 becomes unreachable, the network reachability monitor 108 may move (e.g., transfer) the IP address of the accessory device 104 to a failed address cache. The network reachability monitor 108 may then notify the application module 112 and/or the service registration module 116 that the accessory device 104 is unreachable. In an embodiment, the network reachability monitor 108 may also notify the application module 112 and/or the service registration module 116 to stop scanning for the accessory device 104. Additional details regarding the network reachability monitor will be described below with respect to FIGS. 5-10.

It should be noted that although the electronic device 10 is described as employing the application module 112, the network module 114, and/or the service registration module 116, any of the modules 112, 114, 116 may be employed in a different device (e.g., another computing or electronic device, such as a server) in communication with the electronic device 10. For example, the electronic device 10 may employ the network module 114 and the service registration module 116 and the different device may employ the application module 112. The electronic device 10 may employ a Wi-Fi access point or Ethernet to communicate with the different device, or the different device may include a Wi-Fi access point or Ethernet router. In this manner, implementation of the network reachability monitor 108 by utilizing the application module 112, the network module 114, and/or the service registration module 116 may be deployed by the electronic device 10 and any other suitable device including any of the modules 112, 114, 116.

With the foregoing in mind, FIG. 5 is a block diagram of a flow (e.g., bidirectional flow) of data within the electronic device 10 of FIG. 1 including the network reachability monitor 108 to communicate with the accessory devices 104 of FIG. 4. As described herein, the network module 114 may create and manage the network 100, which may include establishing a first connection 130A with a first accessory device 104A and a second connection 130B with a second accessory device 104B. After connecting to the network 100, the first accessory device 104A and the second accessory device 104B may then complete (e.g., perform, execute) a registration 132 with the service registration module 116 via the network module 114. For example, the first accessory device 104A and the second accessory device 104B may each provide device communication information (e.g., device address, such as the IP address) and/or service information (e.g., device type, device capabilities, and so on) to the service registration module 116. As an example, the service information may include services the accessory devices 104 are associated with, such as a climate control service, a music streaming service, a lighting control service, or any other suitable service.

The service registration module 116 may broadcast (e.g., advertise) the information (e.g., using any suitable protocol, such as mDNS) to enable discovery of the services provided by the first accessory device 104A and the second accessory device 104B by other devices on the network 100. In this manner, the application module 112 may perform a discovery 134 of the first accessory device 104A and the second accessory device 104B via the service registration module 116. Further, the application module 112 may transmit a request to initiate communication 136 with the first accessory device 104A and/or the second accessory device 104B to the network reachability monitor 108 of the network module 114. That is, the application module 112 may request accessory device data, such as a first IP address of the first accessory device 104A and/or a second IP address of the second accessory device 104B from either the network module 114 or the service registration module 116. As described herein, the network reachability monitor 108 may scan for the first accessory device 104A and/or the second accessory device 104B periodically and receive the accessory device data from each reachable accessory device 104. Thus, if the first accessory device 104A and/or the second accessory device 104B are reachable, the network reachability monitor 108 may retrieve (e.g., from the list stored in the address cache) and share (e.g., provide, transmit) the accessory device data 138 with the application module 112 to enable communication with the first accessory device 104A and/or the second accessory device 104B.

In an embodiment, the network reachability monitor 108 may receive an indication of a status change of the network 100 or the accessory device 104. Thus, the network reachability monitor 108 may perform an active scan in response to the status change of the network 100 or the accessory device 104. The network reachability monitor 108 may perform the scan for the accessory devices 104 stored in the address cache and determine an accessory device 104 of the accessory devices 104 is unreachable. The network reachability monitor 108 may perform the active scan after a duration of performing the passive scan if the passive scan cannot reestablish connectivity to the accessory device 104. The network reachability monitor 108 may transmit one or more address queries (e.g., address resolution queries) at aperiodic times, which may be based on an exponential back off. For example, the network reachability monitor 108 may transmit an address query to the accessory device 104. If no response is received (e.g., the accessory device 104 is unreachable), subsequent address queries transmitted by the network reachability monitor 108 may increase in an amount of time between retries (e.g., of transmitting the address queries) to reduce network congestion and enhance efficiency based on the exponential back off. Upon a successful response (e.g., the accessory device 104 is reachable), the network reachability monitor 108 may resolve the IP address to a Routing Locator (RLOC). The duration of performing the passive scan may be dependent on back off policies stored in the application module 112, which may be adjusted, in some embodiments, based on network or user settings.

The network reachability monitor 108 may update the address cache by moving an IP address of the unreachable accessory device 104 to a failed address cache. For example, if the first accessory device 104A is unreachable, then the network reachability monitor 108 may move the first IP address of the first accessory device 104A to the failed address cache. Further, the network reachability monitor 108 may transmit a notification to the application module 112 and/or the service registration module 116 that the accessory device 104 is unreachable. Thus, as an example, the network reachability monitor 108 may transmit the notification to the application module 112 and/or the service registration module 116 that the first accessory device 104A is unreachable.

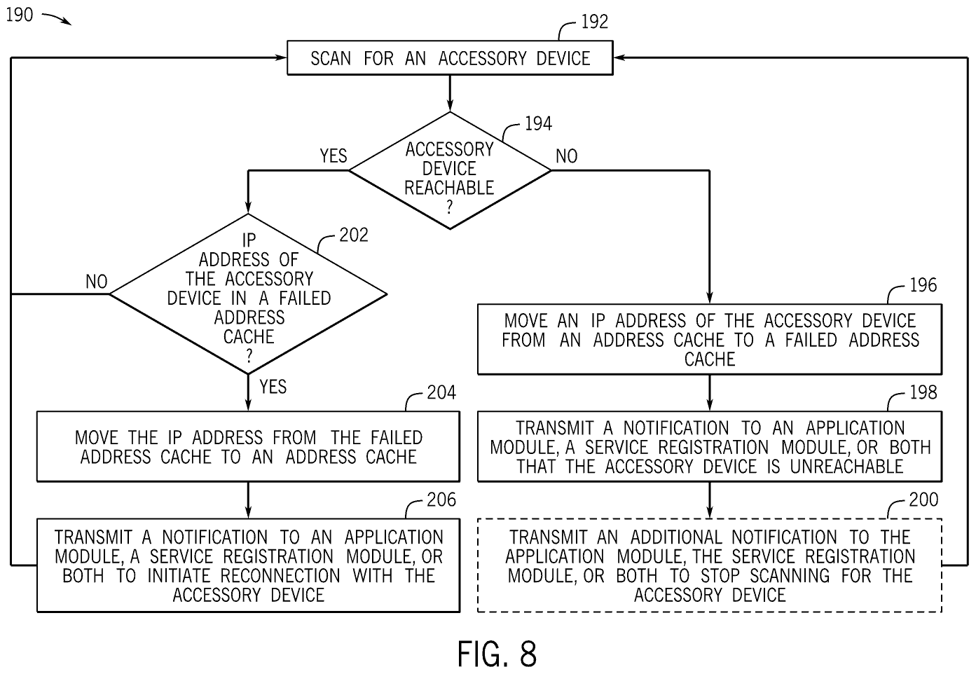

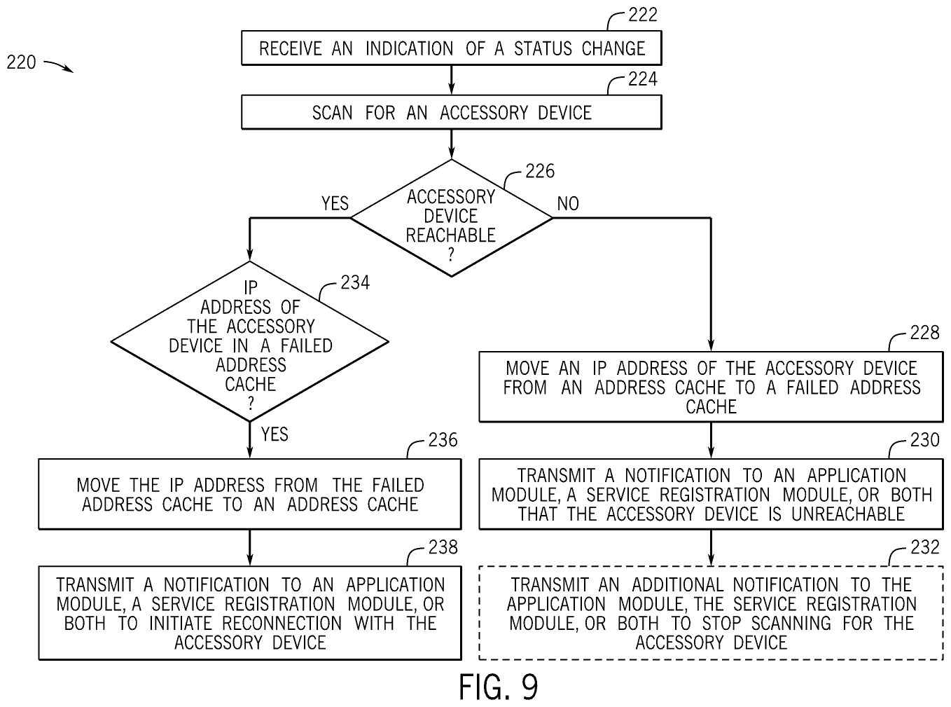

In an embodiment, the network reachability monitor 108 may transmit an additional notification to the application module 112 and/or the service registration module 116 to stop scanning for the accessory device 104. In this manner, the additional notification may enable a faster turnaround time for the application module 112 and/or the service registration module 116 by interrupting the back off mode. The additional notification may prevent the application module 112 and/or the service registration module 116 from entering back off modes, which may reduce or minimize outage duration and/or a duration of connectivity issues. Additional details regarding the active scan will be described below with respect to FIGS. 8 and 9.

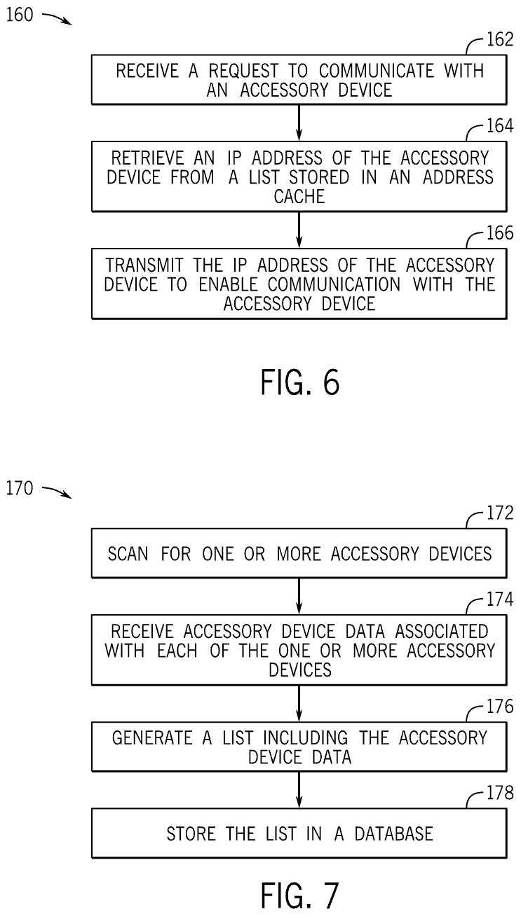

FIG. 6 is a flow diagram of a process 160 for the network reachability monitor of FIG. 5 to transmit an IP address of the accessory device 104. Any suitable device (e.g., a controller) that may control components of the electronic device 10, such as the processor 12 or the transceiver 30, may perform the process 160. In some embodiments, the process 160 may be implemented by executing instructions stored in a tangible, non-transitory, computer-readable medium, such as the memory 14 or the storage 16, using the processor 12 or the transceiver 30. For example, the process 160 may be performed at least in part by one or more software components (e.g., the application module 112, the network module 114, the service registration module 116) such as an operating system of the electronic device 10, one or more software applications of the electronic device 10, and the like. For example, the process 160 may be performed at least in part by the network reachability monitor 108. That is, the processor 12, implementing or executing the network reachability monitor 108 may perform the process 160 described herein. While the process 160 is described using steps in a specific sequence, it should be understood that the present disclosure contemplates that the described steps may be performed in different sequences than the sequence illustrated, and certain described steps may be skipped or not performed altogether.

At process block 162, the processor 12 receives a request to communicate with an accessory device 104 of the accessory devices 104. For example, the application 110 executing on the electronic device 10 may interact and communicate with the accessory device 104. At process block 164, the processor 12 retrieves an IP address of the accessory device 104 from a list stored in an address cache. As described herein, the electronic device 10 may store the list based on the accessory device data received by the network reachability monitor 108 of the electronic device 10. At process block 166, the processor 12 transmits the IP address of the accessory device 104 to enable communication with the accessory device 104.

FIG. 7 is a flow diagram of a process 170 for the electronic device 10 of FIG. 1 to generate the list including the accessory device data. Any suitable device (e.g., a controller) that may control components of the electronic device 10, such as the processor 12 or the transceiver 30, may perform the process 170. In some embodiments, the process 170 may be implemented by executing instructions stored in a tangible, non-transitory, computer-readable medium, such as the memory 14 or the storage 16, using the processor 12 or the transceiver 30. For example, the process 170 may be performed at least in part by one or more software components (e.g., the application module 112, the network module 114, the service registration module 116) such as an operating system of the electronic device 10, one or more software applications of the electronic device 10, and the like. For example, the process 170 may be performed at least in part by the network reachability monitor 108. That is, the processor 12, implementing or executing the network reachability monitor 108 may perform the process 170 described herein. While the process 170 is described using steps in a specific sequence, it should be understood that the present disclosure contemplates that the described steps may be performed in different sequences than the sequence illustrated, and certain described steps may be skipped or not performed altogether.

At process block 172, the network reachability monitor 108, as executed by the processor 12, scans for one or more accessory devices 104. The processor 12 may scan for the accessory devices 104 periodically. These periodic scans may be referred to as proactive or passive scans. As an example, the processor 12 may scan for advertisements from the accessory devices 104, such as Mesh Link Establishment (MLE) advertisements, MLE Child Update Request and/or Response, or any other suitable MLE transaction. As another example, the processor 12 may scan for the accessory devices 104 every five seconds or less, twelve seconds or less, thirty seconds or less, thirty seconds or more, or any other suitable interval (e.g., in seconds, minutes, hours). It should be noted that the intervals, such as a duration or frequency of the intervals, may be configurable (e.g., via user input and/or programming of the electronic device 10). At process block 174, the network reachability monitor 108, as executed by the processor 12, receives the accessory device data associated with each of the accessory devices 104. For example, the accessory device data may include the state, the IP address, the received signal strength indicator (RSSI), the type of the accessory device, the time of the last resolved IP, and any other suitable accessory device information. In an embodiment, the processor 12 may determine a score of the highest performing accessory devices 104 and the lowest performing accessory devices 104 based on the accessory device data.

At process block 176, the network reachability monitor 108, as executed by the processor 12, generates a list that includes the accessory device data (e.g., the IP addresses of the accessory devices 104). Moreover, in an embodiment, the list may include the score of the highest and lowest performing accessory devices 104. Further, it should be noted that when an electronic device (e.g., the electronic device 10 or another electronic device) is elected (e.g., a new leader chosen on the network 100, a user device running the application 110 joins the network 100), the processor 12 may perform and/or continue the one or more scans periodically to maintain the score of the highest and lowest performing accessory devices 104 in the list. Moreover, at process block 178, the network reachability monitor 108, as executed by the processor 12, stores or updates the list in the database, such as the address cache of the network module 114. The processor 12 may employ the address cache as a temporary storage within the network module 114 to enable efficient retrieval of the accessory device data.

In an embodiment, the electronic device 10 may perform an active (e.g., aggressive) scan based on a status change of the network 100 or the accessory devices 104. FIG. 8 is a flow diagram of a process 190 for the electronic device of FIG. 1 to perform the active scan. Any suitable device (e.g., a controller) that may control components of the electronic device 10, such as the processor 12 or the transceiver 30, may perform the process 190. In some embodiments, the process 190 may be implemented by executing instructions stored in a tangible, non-transitory, computer-readable medium, such as the memory 14 or the storage 16, using the processor 12 or the transceiver 30. For example, the process 190 may be performed at least in part by one or more software components (e.g., the application module 112, the network module 114, the service registration module 116) such as an operating system of the electronic device 10, one or more software applications of the electronic device 10, and the like. For example, the process 190 may be performed at least in part by the network reachability monitor 108. That is, the processor 12, implementing or executing the network reachability monitor 108 may perform the process 190 described herein. While the process 190 is described using steps in a specific sequence, it should be understood that the present disclosure contemplates that the described steps may be performed in different sequences than the sequence illustrated, and certain described steps may be skipped or not performed altogether.

At process block 192, the processor 12 scans for an accessory device 104 of the accessory devices 104. As described herein, the processor 12 may store the list including accessory device data of the reachable accessory devices in the address cache. Further, at process block 194, the processor 12 determines if the accessory device 104 is reachable. The processor 12 may scan for the advertisements, such as by encoding advertisement packets for transmission from the accessory device 104, for a period of time (e.g., based on a timer), and determine the accessory device 104 reachability based on receipt of the advertisements (e.g., decoding one or more received advertisement signals). The accessory device 104 may be unreachable due to being powered off, firmware updates, outside a range of the network 100, or any other suitable reason. Further, it should be noted that the period of time may be specified, such as via user input and/or programming.

As an example, the processor 12 may scan for the keep-alive messages from the accessory device 104 and determine the accessory device 104 is reachable based on receiving the keep-alive messages. As another example, the processor 12 may scan for the keep-alive messages from the accessory device 104 for the period of time and determine the accessory device 104 is unreachable based on not receiving the keep-alive messages within the period of time. If the accessory device 104 is not reachable, the process 190 may proceed to process block 196.

At process block 196, the network reachability monitor 108, as executed by the processor 12, moves the IP address of the accessory device 104 from the address cache to a failed address cache. Additionally, the network reachability monitor 108, as executed by the processor 12, may instruct the network module 114 to drop the advertisement packets in response to determining the accessory device 104 is unreachable. Thus, instead of continuously attempting to send or process the advertisement packets, the network module 114 (e.g., Thread module) may drop the advertisement packets. Further, at process block 198, the network reachability monitor 108, as executed by the processor 12, transmits a notification to the application module 112 (e.g., matter module), the service registration module 116, or both, that the accessory device 104 is unreachable. In this manner, the processor 12 may provide information to (e.g., inform) the application module 112 and/or the service registration module 116 of the state of the accessory device 104. Moreover, at process block 200, the network reachability monitor 108, as executed by the processor 12, may optionally transmit an additional notification to the application module 112, the service registration module 116, or both, to stop scanning (e.g., reaching) for the accessory device 104. In this manner, the additional notification may enable a faster turnaround time for the application module 112 and/or the service registration module 116 by interrupting the back off mode.

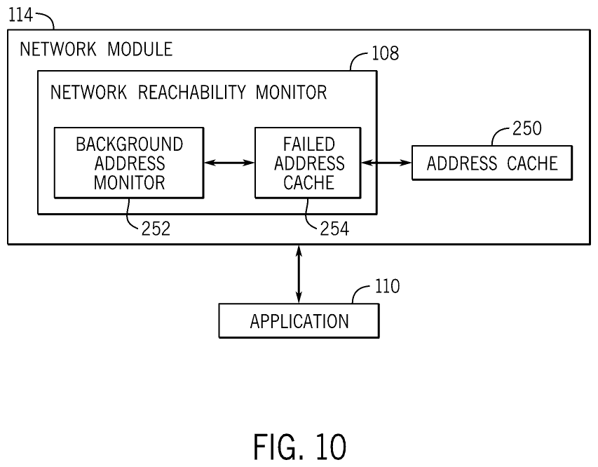

As such, the additional notification may prevent the application module 112 and/or the network module 114 from entering back off modes. Further, the additional notification may shorten a duration of an outage and/or a duration of connectivity issues. As will be described in further detail below with respect to FIG. 10, the network reachability monitor 108 may also include a background monitor to scan for and detect if the accessory becomes reachable again. Thus, the process may proceed back to process block 192 to perform an additional scan for the accessory device 104 at aperiodic (e.g., random) times. The network reachability monitor 108 may transmit an address query for the accessory device 104 based on an exponential back off. That is, if no response is received, the network reliability monitor 108 may increase an amount of time between transmitting a subsequent query. For example, the processor 12 may delay performing the additional scan for a set (e.g., specified) period of time or a default period of time, and the set period of time or the default period of time may increase after each subsequent attempt. Further, it should be noted that upon successful response, the network reachability monitor 108 may resolve the IP address to the RLOC.

With the foregoing in mind, and referring back to process block 194, if the processor 12 determines the accessory device 104 is reachable, the process 190 may proceed to process block 202. At process block 202, the network reachability monitor 108, as executed by the processor 12, determines whether the IP address of the accessory device 104 is in the failed address cache. If the IP address is in the failed address cache, the process 190 proceeds to process block 204. At process block 204, the network reachability monitor 108, as executed by the processor 12, moves the IP address from the failed address cache to the address cache. In addition, at process block 206, the network reachability monitor 108, as executed by the processor 12, transmits a notification to the application module 112, the service registration module 116, or both to initiate reconnection with the accessory device 104. With the foregoing in mind, and referring back to process block 202, if the network reachability monitor 108 determines that the IP address is not in the failed address cache, the process 190 may proceed back to process block 192 to perform the additional scan. For example, the network reachability monitor 108, as executed by the processor 12, may identify or verify the IP address is stored in the list in the address cache.

In another embodiment, the electronic device 10 may perform the active scan based on the status change of the network 100. FIG. 9 is a flow diagram of a process 220 for the electronic device of FIG. 1 to perform the active scan. Any suitable device (e.g., a controller) that may control components of the electronic device 10, such as the processor 12 or the transceiver 30, may perform the process 220. In some embodiments, the process 220 may be implemented by executing instructions stored in a tangible, non-transitory, computer-readable medium, such as the memory 14 or the storage 16, using the processor 12 or the transceiver 30. For example, the process 220 may be performed at least in part by one or more software components (e.g., the application module 112, the network module 114, the service registration module 116) such as an operating system of the electronic device 10, one or more software applications of the electronic device 10, and the like. For example, the process 220 may be performed at least in part by the network reachability monitor 108. That is, the processor 12, implementing or executing the network reachability monitor 108 may perform the process 220 described herein. While the process 220 is described using steps in a specific sequence, it should be understood that the present disclosure contemplates that the described steps may be performed in different sequences than the sequence illustrated, and certain described steps may be skipped or not performed altogether.

At process block 222, the processor 12 receives an indication of the status change. The status change may include a network topology change, a partition change, a reachability trigger, or any other suitable status change. For example, the network topology change may include adding and/or removing devices from the network 100. As another example, the partition change may include the network 100 being split into different partitions (e.g., two or more disjoint portions), which may affect device communication on the network 100. As yet another example, the status change may include a change in the list in the address cache.

In an embodiment, the application 110 may implement triggers to identify if the accessory devices 104 are powered off, undergoing a software update, low on battery (e.g., close to zero battery life), unpaired from the network 100 (e.g., due to a planned outage), and any other suitable condition. In another embodiment, the network reachability monitor 108 may employ machine-learning to identify status changes. For example, the network reachability monitor 108 may retrieve historical data to identify patterns in signal strength, power usage, activity logs, previous update schedules, and so on using the machine-learning. In this manner, the network reachability monitor 108 may make predictions about the status changes of the accessory devices 104.

In some examples, historical data inputs can be fed to network reachability monitor 108. The network reachability monitor 108 can include one or more learning-based and/or non-learning-based models for perceiving, synthesizing, and inferring information. Persons skilled in the art will appreciate that the network reachability monitor 108 can include any suitable number of processes to identify status changes based on input historical data.

Persons of ordinary skill in the art will appreciate that network reachability monitor 108 can include any suitable machine learning models that are well-known or widely available such as regression techniques, classification techniques, neural networks, and deep learning networks. In instances where network reachability monitor 108 comprises a machine-learning based model, network reachability monitor 108 can be trained to identify status changes based on input historical data using one or more well-known or widely available training techniques such as supervised learning, semi-supervised learning, unsupervised learning, and/or reinforcement learning techniques. The training data can include the aforementioned historical data.

Thus, the processor 12 may initiate the active scan similar to the active scan described herein with respect to FIG. 8 based on the indication. That is, at process block 224, scans for the accessory device 104. Further, at process block 226, the processor 12 determines if the accessory device 104 is reachable. If the accessory device 104 is not reachable, the process 220 may proceed to process block 228.

At process block 228, the network reachability monitor 108, as executed by the processor 12, moves the IP address of the accessory device 104 from the address cache to the failed address cache. At process block 230, the network reachability monitor 108, as executed by the processor 12, transmits the notification to the application module 112, the service registration module 116, or both that the accessory device 104 is unreachable. In this manner, the processor 12 may provide information to (e.g., inform) the application module 112 and/or the service registration module 116 of the state of the accessory device 104. At process block 232, the network reachability monitor 108, as executed by the processor 12, optionally transmits the additional notification to the application module 112, the service registration module 116, or both, to stop scanning for the accessory device 104.

With the foregoing in mind, and referring back to process block 226, if the processor 12 determines the accessory device is reachable, the process 220 proceeds to process block 234. At process block 234, the network reachability monitor 108, as executed by the processor 12, determines the IP address of the accessory device 104 is in the failed address cache. If the IP address is in the failed address cache, the process 220 proceeds to process block 236. At process block 236, the network reachability monitor 108, as executed by the processor 12, moves the IP address from the failed address cache to the address cache. In addition, at process block 238, the network reachability monitor 108, as executed by the processor 12, transmits a notification to the application module 112, the service registration module 116, or both to initiate reconnection with the accessory device 104.

With the foregoing in mind, FIG. 10 is a block diagram of the network module 114 of the electronic device 10. As described herein, the network module 114 may include the network reachability monitor 108 and an address cache 250. Further, the network reachability monitor 108 may include a background address monitor 252 and a failed address cache 254. The address cache 250 may be a local temporary storage that stores recently scanned for accessory device data from the accessory devices 104, such as in the list. In this manner, the network reachability monitor 108 may efficiently retrieve the accessory device data from the address cache, such as in response to a request to communicate with the accessory devices 104.

When an accessory device 104 with an IP address stored in the address cache 250 becomes unreachable, the network reachability monitor 108 may move the IP address into the failed address cache 254. The failed address cache 254 may also be a local temporary storage that stores the unreachable accessory devices 104. It should be noted that a number of entries in the failed address cache 254 may be less than or equal to a total number of devices (e.g., the routers 102, the accessory devices 104) on the network 100. The background address monitor 252 may operate on the stale IP address to detect when the accessory device 104 becomes reachable again. The background address monitor 252 may be configurable to scan for a specified period of time. For example, the specified period of time may be based on a user input or based on machine-learning employed by the network reachability monitor 108.

The network module 114, the network reachability monitor 108, and/or the background address monitor 252 may scan for advertisements from the accessory devices 104 to determine reachability. As described herein, the advertisements may include the MLE advertisements, the Child Update Request and/or Response, or any other suitable MLE transaction. As an example, the background address monitor 252 may scan for the accessory device 104, which may be a router. Thus, the router may send periodic keep-alive messages over the network 100 (e.g., part of a Thread protocol). As another example, the background address monitor 252 may scan for the accessory device 104, which may be a sleepy device. The sleepy device may send the Child Update Request to the accessory device 104 over the network 100. As yet another example, the network module 114 may be in communication with the accessory device 104 via a different accessory device (e.g., acting as an intermediate hop), such as a router. Thus, the network module 114 may route Type-Length-Value (TLV) in advertisements to determine if the accessory device 104 is reachable.

As another example, the network module 114 may be in communication with the accessory device 104, which may include the sleepy accessory device, via the different accessory device (e.g., the router). The network reachability monitor 108 may transmit a probe, such as a diagnostic request, to receive a response from the accessory device 104. If the network reachability monitor 108 does not receive the response, then the network reachability monitor 108 may transmit the probe to any number of different accessory devices to receive the response from the accessory device 104. However, if the network reachability monitor 108 does not receive the response from the accessory device 104, then the network reachability monitor 108 may perform the active scan.

As described herein, the network reachability monitor 108 may employ the background address monitor 252 to scan for the unreachable accessory device 104 at aperiodic times within the time period. For example, the background address monitor 252 may scan for the unreachable accessory device 104 at ten minutes, then at twenty minutes later, and then at thirty minutes later. The time period may be set to a total amount of time that the background address monitor 252 may scan for the unreachable accessory device 104. For example, the total amount of time may be sixty minutes. Thus, if the background address monitor 252 determines the accessory device 104 is reachable, the network reachability monitor 108 may clear (e.g., remove, delete) or move the IP address entry from the failed address cache 254.

As described herein, in an embodiment, the network reachability monitor 108 may employ machine-learning to detect the status changes for the accessory devices 104. Further, the network reachability monitor 108 may employ the machine-learning to define the cadence of monitoring the accessory device 104 for the periodic and/or aperiodic scans. In this manner, the network reachability monitor 108 may reduce or minimize power consumption, by only scanning for the accessory device 104 based on categorization techniques of the machine-learning.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S. C. 112(f). However, for any claims containing elements designated in any other manner, it is intended that such elements are not to be interpreted under 35 U.S. C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the network reachability monitoring processes can be used to benefit users.

For example, the data can be used to train models that can be deployed to improve performance, accuracy, and/or functionality of applications and/or services. Accordingly, the use of the data enables the network reachability monitoring processes to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the network reachability monitoring processes are also contemplated by the present disclosure.

The present disclosure contemplates that, in some embodiments, data used by network reachability monitoring processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with network reachability monitoring processes, should attempt to comply with well-established privacy policies and/or privacy practices.

1. One or more tangible, non-transitory computer-readable media storing instructions that, when executed by processing circuitry, are configured to cause the processing circuitry to:
scan for one or more accessory devices;
receive one or more addresses associated with the one or more accessory devices;
generate a list based on the one or more addresses;
receive a request to communicate with an accessory device of the one or more accessory devices; and
prepare an address of the one or more addresses associated with the accessory device for transmission based on the list.

2. The one or more tangible, non-transitory computer-readable media of claim 1, wherein the instructions, when executed by the processing circuitry, cause the processing circuitry to store the list in an address cache.

3. The one or more tangible, non-transitory computer-readable media of claim 2, wherein the instructions, when executed by the processing circuitry, cause the processing circuitry to retrieve the address from the list stored in the address cache.

4. The one or more tangible, non-transitory computer-readable media of claim 1, wherein the instructions, when executed by the processing circuitry, cause the processing circuitry to determine a score of highest performing accessory devices of the one or more accessory devices and lowest performing accessory devices of the one or more accessory devices.

5. The one or more tangible, non-transitory computer-readable media of claim 1, wherein the instructions, when executed by the processing circuitry, cause the processing circuitry to register the one or more accessory devices with a service registration module.

6. The one or more tangible, non-transitory computer-readable media of claim 1, wherein the instructions, when executed by the processing circuitry, cause the processing circuitry to determine that the accessory device is not reachable.

7. The one or more tangible, non-transitory computer-readable media of claim 6, wherein the instructions, when executed by the processing circuitry, cause the processing circuitry to move the address of the accessory device from an address cache to a failed address cache based on the accessory device not being reachable.

8. The one or more tangible, non-transitory computer-readable media of claim 6, wherein the instructions, when executed by the processing circuitry, cause the processing circuitry to prepare a notification for transmission to an application module or a service registration module that the accessory device is not reachable.

9. The one or more tangible, non-transitory computer-readable media of claim 8, wherein the instructions, when executed by the processing circuitry, cause the processing circuitry to prepare an additional notification for transmission to the application module or the service registration module to stop scanning for the accessory device.

10. The one or more tangible, non-transitory computer-readable media of claim 1, wherein the instructions, when executed by the processing circuitry, cause the processing circuitry to determine the address of the accessory device is in a failed address cache.

11. The one or more tangible, non-transitory computer-readable media of claim 10, wherein the instructions, when executed by the processing circuitry, cause the processing circuitry to move the address from the failed address cache to an address cache.

12. An electronic device comprising:
a transmitter;
a receiver;
processing circuitry coupled to the transmitter and the receiver, the processing circuitry configured to:
cause the receiver to scan for one or more accessory devices at a first time;
cause the receiver to receive one or more addresses associated with the one or more accessory devices;
generate a list based on the one or more addresses;
cause the receiver to receive a request to communicate with an accessory device of the one or more accessory devices; and
cause the transmitter to transmit an address of the one or more addresses associated with the accessory device based on the list.

13. The electronic device of claim 12, wherein the processing circuitry is configured to:
receive an indication of a status change;
cause the receiver to scan for the accessory device at a second time;
determine that the accessory device is not reachable; and
move the address from an address cache to a failed address cache.

14. The electronic device of claim 13, wherein the status change comprises a network topology change, a partition change, or a reachability trigger.

15. The electronic device of claim 13, wherein the processing circuitry is configured to:
cause the receiver to scan for the accessory device at a third time after the second time;
determine that the accessory device is reachable at the third time; and
move the address from the failed address cache to the address cache.

16. The electronic device of claim 15, wherein the processing circuitry is configured to cause the transmitter to transmit a notification to an application module or a service registration module to initiate reconnection with the accessory device.

17. The electronic device of claim 12, wherein the address comprises an Internet Protocol address.

18. A method to be performed by processing circuitry comprising:
scanning for one or more accessory devices;
receiving one or more addresses associated with the one or more accessory devices;
generating a list based on the one or more addresses;
receiving a request to communicate with the accessory devices; and
preparing for transmission, an address of the one or more addresses associated with the accessory device based on the list.

19. The method of claim 18, comprising storing the list in an address cache.

20. The method of claim 19, comprising retrieving the address from the list stored in the address cache.
